(19) United States
(12) Patent Application Publication
(10) Pub. No.: US 2026/0188807 A1
(43) Pub. Date: Jul. 2, 2026

(54) SECONDARY BATTERY AND ELECTRIC DEVICE

(71) Applicant: Ningde Amperex Technology Limited, Ningde (CN)

(72) Inventors: Qiaofeng CHEN, Ningde (CN); Guowen ZHANG, Ningde (CN); Jiaxu YU, Ningde (CN); Jufeng ZHOU, Ningde (CN)

(73) Assignee: Ningde Amperex Technology Limited, Ningde (CN)

(21) Appl. No.: 19/433,473

(22) Filed: Dec. 26, 2025

(30) Foreign Application Priority Data
Dec. 28, 2024 (CN) 202411958264.8

(51) Int. Cl. H01M 50/184; H01M 10/0585; H01M 50/103; H01M 50/186; H01M 50/474

(52) U.S. Cl. CPC H01M 50/184; H01M 10/0585; H01M 50/103; H01M 50/186; H01M 50/474

(57) ABSTRACT

A secondary battery includes a housing, an electrode assembly, and a sealing member. The housing includes a first housing body and a second housing body. The first housing body includes a first wall and a first side wall connected to a periphery of the first wall, and the second housing body includes a second wall and a second side wall connected to a periphery of the second wall. The housing has a corner portion, a part of the corner portion is disposed on the first side wall, and another part of the corner portion is disposed on the second side wall. The sealing member includes a first fastening portion and a second fastening portion, and along a thickness direction of the sealing member, the first fastening portion and the second fastening portion are stacked on the corner portion.

### CROSS-REFERENCE TO RELATED APPLICATION

This application claims priority to the Chinese Patent Application Serial No. 202411958264.8, filed on Dec. 28, 2024, the content of which is incorporated herein by reference in its entirety.

### TECHNICAL FIELD

This application relates to the field of energy storage technology, and in particular, to a secondary battery and an electric device.

### BACKGROUND

Current secondary batteries include steel-shell batteries and pouch batteries. Generally, steel-shell batteries and pouch batteries both include a housing and an electrode assembly disposed in the housing. The housing of the steel-shell battery includes a first housing body and a second housing body, where the first housing body and the second housing body are sealed and connected by welding.

### SUMMARY

For the secondary battery in the prior art, the inventors have found that stresses are generated in the process of sealing and connecting the first housing body and the second housing body by welding, and these stresses easily lead to defects such as cracks in the weld seam, thereby affecting the sealing performance of the secondary battery. Moreover, welding connection between the first housing body and the second housing body leads loss of the energy density of the secondary battery to a certain extent.

In view of the above situation, it is necessary to provide a secondary battery that can improve the sealing performance between the first housing body and the second housing body, and reduce the loss of energy density of the secondary battery.

A first aspect of this application provides a secondary battery, including a housing, an electrode assembly, and a sealing member. The housing includes a first housing body and a second housing body, where the first housing body and the second housing body together form an accommodating cavity, the accommodating cavity is filled with an electrolyte, and the electrode assembly is disposed in the accommodating cavity. The first housing body includes a first wall and a first side wall connected to a periphery of the first wall, and the second housing body includes a second wall and a second side wall connected to a periphery of the second wall. Along a first direction, the first wall is disposed opposite to the second wall, and the first side wall is joined to the second side wall. The housing has a corner portion, a part of the corner portion is disposed on the first side wall, and another part of the corner portion is disposed on the second side wall. The sealing member is disposed around a periphery of the first housing body and the second housing body, and seals a joint between the first side wall and the second side wall. The sealing member includes a first fastening portion and a second fastening portion disposed at two end portions along an extension direction of the sealing member, and along a thickness direction of the sealing member, the first fastening portion and the second fastening portion are stacked on the corner portion. The first fastening portion is fixedly connected to the second fastening portion.

Sealing the joint between the first side wall and the second side wall with the sealing member helps improve the sealing performance of the first housing body and the second housing body. Along the thickness direction of the sealing member, the first fastening portion and the second fastening portion of the sealing member are stacked, which can increase an area of the sealing member for fastening, and help improve stability of the sealing member. On the basis of the stacked arrangement, the first fastening portion and the second fastening portion are disposed on the corner portion, so that the first fastening portion and the second fastening portion can utilize a part of space at the corner portion, helping reduce loss of energy density of the secondary battery.

In one or more of the above embodiments, the sealing member further includes a third fastening portion, one end of the third fastening portion is connected to the first fastening portion, and another end of the third fastening portion is connected to the second fastening portion. Along an extension direction of the corner portion, the corner portion has a first boundary and a second boundary. Along a direction perpendicular to the first boundary and a direction perpendicular to the second boundary, projections of the first fastening portion and the second fastening portion both are located within a projection range of the third fastening portion. In this case, additional space occupied by the stacked first fastening portion and second fastening portion can be reduced, helping reduce loss of energy density of the secondary battery.

In one or more of the above embodiments, observed along the first direction, the corner portion is arc-shaped. The first direction is parallel to a thickness direction of the housing. In this case, the housing has better deformation resistance at the corner portion, helping reduce the risk of leakage caused by damage to the corner portion after the secondary battery falls. Moreover, the space of the corner portion becomes more uniform, helping improve the utilization of the space of the corner portion by the stacked first fastening portion and second fastening portion.

In one or more of the above embodiments, the secondary battery further includes a first tab, and the first tab is connected to the electrode assembly and extends out of the electrode assembly along a second direction. Along a third direction, a projection of the corner portion at least partially covers a projection of the first tab. The first direction, the second direction, and the third direction are perpendicular to each other. In this case, the corner portion is disposed close to the first tab. Since a relatively large space for disposing the first tab is required between the electrode assembly and the housing, if the secondary battery falls, a part of the sealing member located at the corner portion may be easily damaged. Stacking the first fastening portion and the second fastening portion on the corner portion close to the first tab can thicken the part of the sealing member located at the corner portion, helping reduce the risk of leakage of the secondary battery caused by damage to the sealing member. Moreover, since a relatively large space for disposing the first tab is required between the electrode assembly and the housing, the space of the corner portion may be relatively large, which can better accommodate the stacked first fastening portion and second fastening portion and help better reduce the loss of energy density of the secondary battery.

In one or more of the above embodiments, the electrode assembly includes a first edge. The first tab extends out of the first edge along the second direction. Along the second direction, a distance between the first edge and the housing is D. A radius of the corner portion is R, where 0.77 mm≤R≤D. In most cases, R being greater than or equal to 0.77 mm can ensure that the projections of the first fastening portion and the second fastening portion both are located within the projection range of the third fastening portion along the direction perpendicular to the first boundary and the direction perpendicular to the second boundary, helping better reduce the loss of energy density of the secondary battery. R being less than or equal to D ensures that the corner portion is spaced from the electrode assembly and the first tab, helping reduce extrusion of the corner portion on the electrode assembly and the first tab.

In one or more of the above embodiments, observed along the first direction, a length of the corner portion is L₁, and a length of the second fastening portion is L₂, where 0.3 mm≤L₂<L₁. L₂ being greater than or equal to 0.3 mm can ensure a relatively large overlapping area of the stacked first fastening portion and second fastening portion, helping improve sealing performance at a fixed connection between the first fastening portion and the second fastening portion. L₂ being less than L₁ can reduce the possibility that the first fastening portion and the second fastening portion respectively exceed the first boundary and the second boundary along their respective extension directions, helping better reduce the loss of energy density of the secondary battery.

In one or more of the above embodiments, a thickness of the sealing member is d₀, where 14 μm≤d₀≤300 μm. Herein, d₀ being greater than or equal to 14 μm can improve the overall strength of the sealing member, helping further reduce the risk of leakage failure of the secondary battery caused by damage to the sealing member after the secondary battery falls; and d₀ being less than or equal to 300 μm allows the sealing member to maintain sufficient overall strength for most falling situations, further reducing the space occupied by the sealing member, helping further reduce the loss of energy density of the secondary battery.

In one or more of the above embodiments, the sealing member includes a first adhesive layer and a metal layer. The first adhesive layer is bonded to the first housing body and the second housing body. The metal layer is disposed on a side of the first adhesive layer facing away from the first housing body and the second housing body. The water resistance of the metal layer is better than that of the first adhesive layer, helping improve the sealing performance of the sealing member to the first housing body and the second housing body. Moreover, under the same sealing performance requirements, since the water resistance of the metal layer is better than that of the first adhesive layer, compared with the sealing member including only the first adhesive layer, the sealing member has a reduced overall thickness due to the inclusion of the metal layer in the sealing member, helping reduce the loss of energy density of the secondary battery.

In one or more of the above embodiments, the sealing member further includes a second adhesive layer, and the second adhesive layer is disposed on a side of the metal layer facing away from the first adhesive layer. The second adhesive layer can protect the metal layer, helping reduce the risk of failure due to damage to the metal layer, thereby helping maintain the sealing performance of the sealing member to the first housing body and the second housing body during the long-term use of the secondary battery.

In one or more of the above embodiments, a positive electrode of the electrode assembly is electrically connected to the first housing body, and a negative electrode of the electrode assembly is electrically connected to the second housing body. The first housing body is insulated from the second housing body. This helps reduce the risk of short circuit in the secondary battery.

In one or more of the above embodiments, the secondary battery further includes an insulating member. Along the first direction, a gap exists between the first side wall and the second side wall. The insulating member is disposed in the gap and connects the first side wall and the second side wall. The insulating member helps improve the convenience of insulating arrangement between the first housing body and the second housing body.

In one or more of the above embodiments, the insulating member is integrally formed with the sealing member. In this case, the insulating member may be directly formed by cooling after a part of the sealing member is melted and enters the gap between the first housing body and the second housing body. This simplifies the assembly process of the secondary battery and the process for preparing the secondary battery. Moreover, since the insulating member and the sealing member are integrally formed, conformity to the gap between the first housing body and the second housing body is achieved, helping further improve the sealing performance of the sealing member to the first housing body and the second housing body.

A second aspect of this application provides an electric device, including the secondary battery of the first aspect of this application. The secondary battery has relatively good sealing performance, and therefore electrolyte leakage is less likely, helping extend the service life of the electric device. The secondary battery has less loss of energy density, and the battery capacity can be higher, helping improve the endurance capability of the electric device.

### BRIEF DESCRIPTION OF THE DRAWINGS

FIG. 1 is a top view of a secondary battery according to an embodiment of this application.

FIG. 2 is a front view of a secondary battery according to an embodiment of this application.

FIG. 3 is an exploded view of a secondary battery according to an embodiment of this application.

FIG. 4 is an enlarged view of region C in FIG. 3 according to an embodiment of this application.

FIG. 5 is a sectional view along section line A-A in FIG. 1 according to an embodiment of this application.

FIG. 6 is a sectional view along section line B-B in FIG. 2 according to a first embodiment of this application.

FIG. 7 is a sectional view along section line B-B in FIG. 2 according to a second embodiment of this application.

FIG. 8 is a sectional view along section line B-B in FIG. 2 according to a third embodiment of this application.

FIG. 9 is an overall schematic diagram of an electric device according to an embodiment of this application.

### Description of Main Reference Signs

1000. electric device; 100. secondary battery; 10. housing; 101. accommodating cavity; 102. corner portion; 1021. first boundary; 1022. second boundary; 103. bonding member; 11. first housing body; 111. first wall; 112. first side wall; 12. second housing body; 121. second wall; 122. second side wall; 20. electrode assembly; 201. first tab; 202. second tab; 21. first electrode plate; 22. second electrode plate; 23. separator; 24. first edge; 30. sealing member; 301. first fastening portion; 302. second fastening portion; 303. third fastening portion; 31. first adhesive layer; 311. first part; 312. second part; 32. metal layer; 33. second adhesive layer; 40. insulating member; and X. first direction.

### DETAILED DESCRIPTION

The technical solutions in some embodiments of this application are described below with reference to the drawings in some embodiments of this application. It is clear that the described embodiments are only some but not all embodiments of this application.

It should be noted that when an element is considered to be “connected” to another element, it may be connected to another element directly or through an intervening element. When an element is considered to be “disposed on” another element, it may be disposed on another element directly or through an intervening element.

Unless otherwise specified, the term “a plurality of” used herein refers to two or more.

The terms “first”, “second”, and the like are only used to distinguish different objects, and cannot be understood as indications or implications of relative importance or implication of the number, specific order or primary-secondary relationship of the indicated technical features.

Unless otherwise defined, all technical and scientific terms used herein have the same meaning as commonly understood by those skilled in the art of this application. The terms used in the specification of this application herein are only for the purpose of describing specific embodiments, and are not intended to limit this application. The term “and/or” used herein includes any and all combinations of one or more related listed items.

It should be understood that, considering the factors of actual processing tolerance, in the technical solutions of this application, when two elements are arranged parallel/perpendicular to each other along the same direction, a certain angle may exist between the two elements, a tolerance of 0% to ±10% is allowed between the two elements.

An embodiment of this application provides a secondary battery, including a housing, an electrode assembly, and a sealing member. The housing includes a first housing body and a second housing body, where the first housing body and the second housing body together form an accommodating cavity, the accommodating cavity is filled with an electrolyte, and the electrode assembly is disposed in the accommodating cavity. The first housing body includes a first wall and a first side wall connected to a periphery of the first wall, and the second housing body includes a second wall and a second side wall connected to a periphery of the second wall. Along a first direction, the first wall is disposed opposite to the second wall, and the first side wall is joined to the second side wall. The housing has a corner portion, a part of the corner portion is disposed on the first side wall, and another part of the corner portion is disposed on the second side wall. The sealing member is disposed around a periphery of the first housing body and the second housing body, and seals a joint between the first side wall and the second side wall. The sealing member includes a first fastening portion and a second fastening portion disposed at two end portions along an extension direction of the sealing member, and along a thickness direction of the sealing member, the first fastening portion and the second fastening portion are stacked on the corner portion. The first fastening portion is fixedly connected to the second fastening portion.

In the secondary battery of this application, sealing the joint between the first side wall and the second side wall with the sealing member helps improve the sealing performance of the first housing body and the second housing body. Along the thickness direction of the sealing member, the first fastening portion and the second fastening portion of the sealing member are stacked, which can increase an area of the sealing member for fastening, and help improve stability of the sealing member. On the basis of the stacked arrangement, the first fastening portion and the second fastening portion are disposed on the corner portion, so that the first fastening portion and the second fastening portion can utilize a part of space at the corner portion, helping reduce loss of energy density of the secondary battery.

Some embodiments of this application are described below with reference to the drawings. In the absence of conflict, the following embodiments and features in the embodiments can be combined with each other.

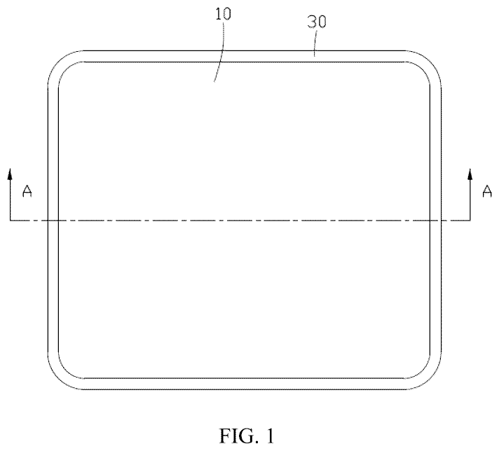

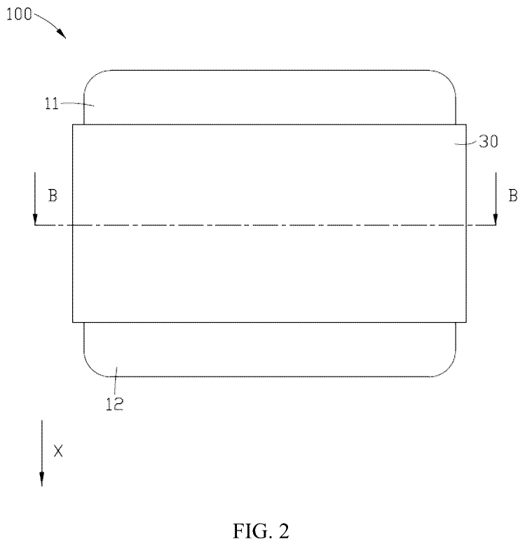

Refer to FIG. 1 to FIG. 5. An embodiment of this application provides a secondary battery 100, including a housing 10, an electrode assembly 20, and a sealing member 30, where the electrode assembly 20 is accommodated in the housing 10, and the sealing member 30 is configured to seal the housing 10.

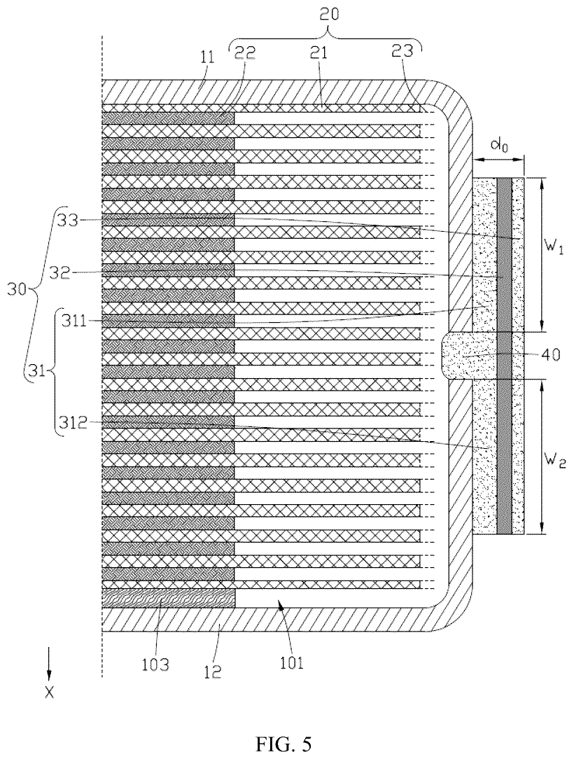

Refer to FIG. 5. The housing 10 has an accommodating cavity 101, the accommodating cavity 101 is filled with an electrolyte, and the electrode assembly 20 is disposed in the accommodating cavity 101.

In some embodiments, with reference to FIG. 5, the housing 10 includes a first housing body 11 and a second housing body 12, where the first housing body 11 and the second housing body 12 are joined along a first direction X, and together form an accommodating cavity 101.

In some embodiments, the first direction X is parallel to a thickness direction of the housing 10. In some other embodiments, the first direction X is parallel to a length direction or a width direction of the housing 10.

In some embodiments, the first housing body 11 is insulated from the second housing body 12. In some other embodiments, the first housing body 11 is electrically connected to the second housing body 12.

In some embodiments, the housing 10 is a metal housing, and a material of the housing 10 includes at least one of steel alloy, aluminum alloy, or copper alloy. A material of the first housing body 11 and the second housing body 12 includes at least one of steel alloy, aluminum alloy, or copper alloy.

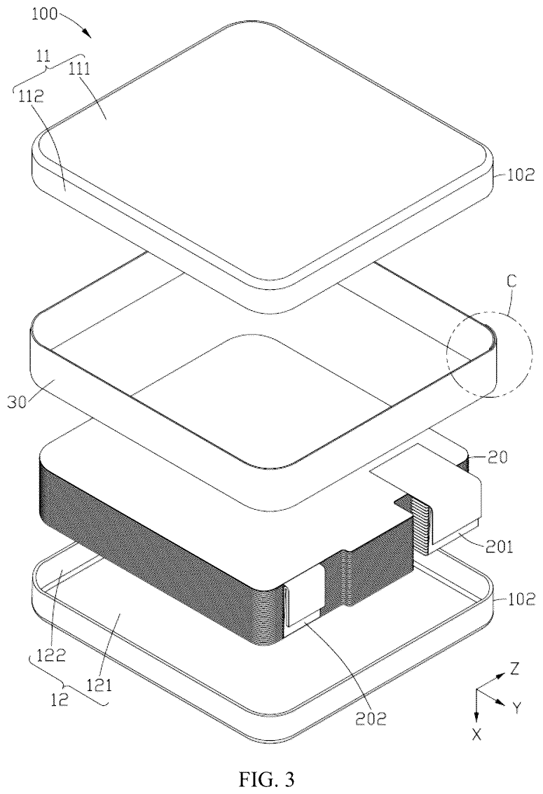

In some embodiments, with reference to FIG. 3, the first housing body 11 includes a first wall 111 and a first side wall 112, where the first side wall 112 is connected to a periphery of the first wall 111. The second housing body 12 includes a second wall 121 and a second side wall 122, where the second side wall 122 is connected to a periphery of the second wall 121. Along the first direction X, the first wall 111 is disposed opposite to the second wall 121, and the first side wall 112 is joined to the second side wall 122. In some embodiments, along the first direction X, a gap exists between the first side wall 112 and the second side wall 122.

In some embodiments, with reference to FIG. 3, the housing 10 includes a corner portion 102, a part of the corner portion 102 is disposed on the first side wall 112, and another part of the corner portion 102 is disposed on the second side wall 122. In the first housing body 11, a part of the corner portion 102 is a transition portion connecting two adjacent edges of the first side wall 112, and in the second housing body 12, another part of the corner portion 102 is a transition portion connecting two adjacent edges of the second side wall 122.

Refer to FIG. 5. The electrode assembly 20 includes a first electrode plate 21, a second electrode plate 22, and a separator 23, where the second electrode plate 22 has a polarity opposite that of the first electrode plate 21, and the separator 23 separates the first electrode plate 21 from the second electrode plate 22.

In some embodiments, with reference to FIG. 5, the electrode assembly 20 is a stacked structure, where a plurality of first electrode plates 21 and a plurality of second electrode plates 22 are alternately stacked, and the separator 23 is disposed between any adjacent first electrode plate 21 and second electrode plate 22.

In some embodiments, the electrode assembly 20 is a wound structure, where a single first electrode plate 21 and a single second electrode plate 22 are stacked and then wound, and the separator 23 is disposed between the first electrode plate 21 and the second electrode plate 22.

In some embodiments, the first electrode plate 21 is a negative electrode plate, and the second electrode plate 22 is a positive electrode plate. In some embodiments, the first electrode plate 21 is a positive electrode plate, and the second electrode plate 22 is a negative electrode plate. Along a thickness direction of the electrode assembly 20, a projection of the negative electrode plate covers a projection of the positive electrode plate.

In some embodiments, the first electrode plate 21 includes a first current collector and a first active material layer, where the first current collector is disposed on two opposite surfaces of the first active material layer along a thickness direction. The second electrode plate 22 includes a second current collector and a second active material layer, where the second current collector is disposed on two opposite surfaces of the second active material layer along a thickness direction. In some embodiments, when the first electrode plate 21 or the second electrode plate 22 is an outermost electrode plate of the electrode assembly 20, a surface of the current collector facing away from an interior of the electrode assembly 20 may not be provided with an active material layer.

In some embodiments, a material of the first current collector includes at least one of copper, nickel, tantalum, or titanium, and a material of the second current collector includes at least one of aluminum, nickel, tantalum, or titanium.

In some embodiments, a material of the first active material layer includes at least one of graphite, hard carbon, soft carbon, silicon, silicon-oxygen material, or silicon-carbon material. A material of the second active material layer includes at least one of lithium cobalt oxide, lithium nickel cobalt manganese oxide, lithium nickel cobalt aluminate, lithium iron phosphate, lithium manganese iron phosphate, or lithium manganese oxide.

In some embodiments, the separator 23 is an insulating film material such as a polyethylene film, a polypropylene film, a polyester film, or a polyimide film.

In some embodiments, a positive electrode of the electrode assembly 20 is electrically connected to the first housing body 11, and a negative electrode of the electrode assembly 20 is electrically connected to the second housing body 12, where the first housing body 11 is insulated from the second housing body 12, helping reduce the risk of short circuit in the secondary battery 100.

In some embodiments, with reference to FIG. 3, the secondary battery 100 further includes a plurality of first tabs 201 and a plurality of second tabs 202, where the first tabs 201 and the second tabs 202 are connected to the electrode assembly 20, and extend along a second direction Y. The second direction Y is perpendicular to the first direction X. In some embodiments, the first tabs 201 are connected to the first electrode plate 21, and the second tabs 202 are connected to the second electrode plate 22.

In some embodiments, the plurality of first tabs 201 are gathered to form a first tab bundle, and the plurality of second tabs 202 are gathered to form a second tab bundle. One of the first tab bundle and the second tab bundle is electrically connected to the first housing body 11, and the other of the first tab bundle and the second tab bundle is electrically connected to the second housing body 12.

In some embodiments, with reference to FIG. 5, the secondary battery 100 further includes an insulating member 40. Along the first direction X, the insulating member 40 is disposed in the gap between the first side wall 112 and the second side wall 122, and connects the first side wall 112 and the second side wall 122. The insulating member 40 helps improve the convenience of insulating arrangement of the first housing body 11 and the second housing body 12.

In some embodiments, one of a positive electrode and a negative electrode of the electrode assembly 20 is electrically connected to the housing 10, and the other of the positive electrode and the negative electrode of the electrode assembly 20 maintains an insulated connection with the housing 10, where the first housing body 11 is electrically connected to the second housing body 12. For example, one of the positive electrode and the negative electrode of the electrode assembly 20 is electrically connected to the housing 10, and the other of the positive electrode and the negative electrode of the electrode assembly 20 is electrically connected to a terminal post (not shown), where the terminal post is disposed on the housing 10 and insulated from the housing 10.

Refer to FIG. 3 to FIG. 5. The sealing member 30 is disposed around the periphery of the first housing body 11 and the periphery of the second housing body 12, and seals a joint between the first side wall 112 and the second side wall 122. Along a thickness direction of the sealing member 30, a projection of the sealing member 30 at least partially covers projections of the first housing body 11 and the second housing body 12. Sealing the joint between the first side wall 112 and the second side wall 122 with the sealing member 30 helps improve the sealing performance between the first housing body 11 and the second housing body 12.

In some embodiments, along the first direction X, projections of the first housing body 11 and the second housing body 12 are both located within a closed area enclosed by the projection of the sealing member 30. In some other embodiments, along the first direction X, a projection of the first housing body 11 is located within a closed area enclosed by the projection of the sealing member 30, and the projection of the second housing body 12 at least partially covers the projection of the sealing member 30.

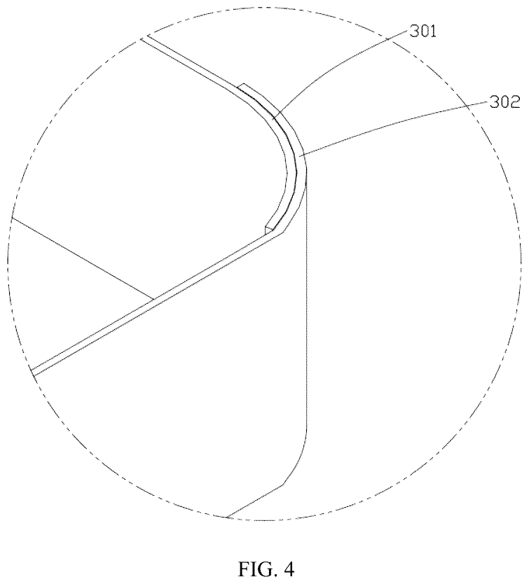

In some embodiments, with reference to FIG. 4, along an extension direction of the sealing member 30, the sealing member 30 includes a first fastening portion 301 and a second fastening portion 302 disposed at two end portions.

In some embodiments, along the thickness direction of the sealing member 30, the first fastening portion 301 and the second fastening portion 302 are stacked. The first fastening portion 301 is fixedly connected to the second fastening portion 302. In this case, an area of the sealing member 30 for fastening is increased, helping improve the stability of the sealing member 30.

In some embodiments, the first fastening portion 301 and the second fastening portion 302 are stacked on the corner portion 102. On the basis of the stacked arrangement, the first fastening portion 301 and the second fastening portion 302 are disposed on the corner portion 102, so that the first fastening portion 301 and the second fastening portion 302 can utilize a part of space of the corner portion 102, helping reduce loss of energy density of the secondary battery 100. The space of the corner portion 102 refers to a space enclosed by the corner portion 102 and extended parts of two edges that are connected by the corner portion 102 and intersect with each other.

In some other embodiments, along the thickness direction of the sealing member 30, the projection of the first fastening portion 301 is separated from the projection of the second fastening portion 302, and the sealing member 30 is a continuous ring. The sealing member 30 has heat-shrinkable property, and before sealing, the sealing member 30 has a larger size for fitting over the joint between the first side wall 112 and the second side wall 122; after sealing, the size of the sealing member 30 is reduced for sealing the joint between the first side wall 112 and the second side wall 122.

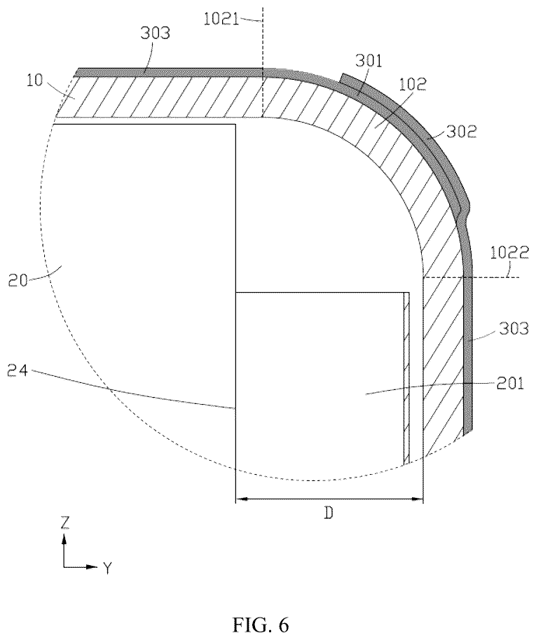

In some embodiments, with reference to FIG. 6 to FIG. 8, along an extension direction of the corner portion 102, the corner portion 102 has a first boundary 1021 and a second boundary 1022, and the first fastening portion 301 and the second fastening portion 302 are located between the first boundary 1021 and the second boundary 1022. Refer to FIG. 6 to FIG. 8. The first boundary 1021 and second boundary 1022 refer to boundaries of two end surfaces of the corner portion 102 along the extension direction of the corner portion 102 observed along the first direction X.

In some embodiments, the sealing member 30 further includes a third fastening portion 303, one end of the third fastening portion 303 is connected to the first fastening portion 301, and another end of the third fastening portion 303 is connected to the second fastening portion 302. Along a direction perpendicular to the first boundary 1021 and a direction perpendicular to the second boundary 1022, projections of the first fastening portion 301 and the second fastening portion 302 are both located within a projection range of the third fastening portion 303. In this case, additional space occupied by the stacked first fastening portion 301 and second fastening portion 302 can be reduced, helping reduce loss of energy density of the secondary battery 100. It should be understood that, considering the factors of actual processing tolerance, the projections of the first fastening portion 301 and the second fastening portion 302 both located within the projection range of the third fastening portion 303 allow for a 10% error, that is, at most 10% of the projections of the first fastening portion 301 and the second fastening portion 302 are allowed to be outside the projection range of the third fastening portion 303.

In some embodiments, with reference to FIG. 6, observed along the first direction X, the corner portion 102 is arc-shaped. In this case, the housing 10 has better deformation resistance at the corner portion 102, helping reduce the risk of leakage caused by damage to the corner portion 102 after the secondary battery 100 falls. Moreover, the space of the corner portion 102 becomes more uniform, helping improve the utilization of the space of the corner portion 102 by the stacked first fastening portion 301 and second fastening portion 302.

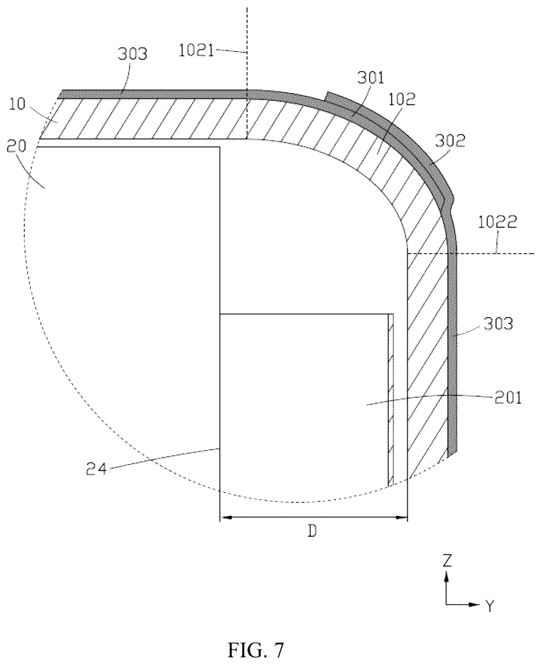

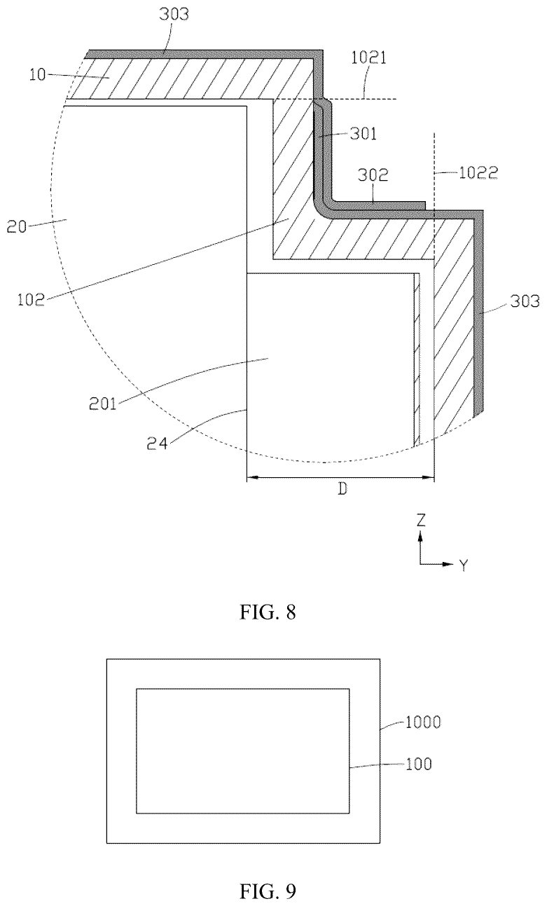

In some other embodiments, with reference to FIG. 7, observed along the first direction X, the corner portion 102 is elliptical arc-shaped. In some other embodiments, with reference to FIG. 8, observed along the first direction X, the corner portion 102 is L-shaped.

In some embodiments, along the third direction Z, a projection of the corner portion 102 at least partially covers a projection of the first tab 201. The first direction X, the second direction Y, and the third direction Z are perpendicular to each other. In this case, the corner portion 102 is disposed close to the first tab 201. Since a relatively large space for disposing the first tab 201 is required between the electrode assembly 20 and the housing 10, if the secondary battery 100 falls, a part of the sealing member 30 located at the corner portion 102 may be easily damaged. Stacking the first fastening portion 301 and the second fastening portion 302 on the corner portion 102 close to the first tab 201 can thicken the part of the sealing member 30 located at the corner portion 102, helping reduce the risk of leakage of the secondary battery 100 caused by damage to the sealing member 30. Moreover, since a relatively large space for disposing the first tab 201 is required between the electrode assembly 20 and the housing 10, the space of the corner portion 102 may be relatively large, which can better accommodate the stacked first fastening portion 301 and second fastening portion 302 and help better reduce the loss of energy density of the secondary battery 100.

In some embodiments, with reference to FIG. 6 to FIG. 8, the electrode assembly 20 includes a first edge 24, where the first tab 201 extends out of the first edge 24 along the second direction Y. Along the second direction Y, a distance between the first edge 24 and the housing 10 is D.

In some embodiments, with reference to FIG. 6, observed along the first direction X, the corner portion 102 is arc-shaped, and a radius of the corner portion 102 is R, where 0.77 mm≤R≤D. In most cases, R being greater than or equal to 0.77 mm can ensure that the projections of the first fastening portion 301 and the second fastening portion 302 both are located within the projection range of the third fastening portion 303 along the direction perpendicular to the first boundary 1021 and the direction perpendicular to the second boundary 1022, helping better reduce the loss of energy density of the secondary battery 100. R being less than or equal to D ensures that the corner portion 102 is spaced from the electrode assembly 20 and the first tab 201, helping reduce extrusion of the corner portion 102 on the electrode assembly 20 and the first tab 201. The so-called most cases may be, for example, a case that a thickness of the sealing member 30 is 14 μm to 300 μm, and observed along the first direction X, a size of the second fastening portion 302 along an extension direction of the second fastening portion 302 is at least 0.3 mm.

In some embodiments, 1 mm≤D≤3 mm.

In some embodiments, along the first direction X, a length of the corner portion 102 is L₁, and a length of the second fastening portion 302 is L₂, where 0.3 mm≤L₂<L₁. L₂ being greater than or equal to 0.3 mm can ensure a relatively large overlapping area of the stacked first fastening portion 301 and second fastening portion 302, helping improve sealing performance at a fixed connection between the first fastening portion 301 and the second fastening portion 302. L₂ being less than L₁ can reduce the possibility that the first fastening portion 301 and the second fastening portion 302 respectively exceed the first boundary 1021 and the second boundary 1022 along their respective extension directions, helping better reduce the loss of energy density of the secondary battery 100.

In some embodiments, with reference to FIG. 5, the sealing member 30 includes a first adhesive layer 31 and a metal layer 32, where the first adhesive layer 31 is bonded to the first housing body 11 and the second housing body 12, and the metal layer 32 is disposed on a side of the first adhesive layer 31 facing away from the first housing body 11 and the second housing body 12. The water resistance of the metal layer 32 is better than that of the first adhesive layer 31, helping improve the sealing performance of the sealing member 30 to the first housing body 11 and the second housing body 12. Moreover, under the same sealing performance requirements, since the water resistance of the metal layer 32 is better than that of the first adhesive layer 31, compared with the sealing member 30 including only the first adhesive layer 31, the sealing member 30 has a reduced overall thickness due to the inclusion of the metal layer 32 in the sealing member 30, helping reduce the loss of energy density of the secondary battery 100.

In some embodiments, when the sealing member 30 includes the first adhesive layer 31 and the metal layer 32, the first adhesive layer 31 of the second fastening portion 302 is fixedly connected to the metal layer 32 of the first fastening portion 301.

In some embodiments, with reference to FIG. 5, the sealing member 30 further includes a second adhesive layer 33, and the second adhesive layer 33 is disposed on a side of the metal layer 32 facing away from the first adhesive layer 31. The second adhesive layer 33 can protect the metal layer 32, helping reduce the risk of failure due to damage to the metal layer 32, thereby helping maintain the sealing performance of the sealing member 30 to the first housing body 11 and the second housing body 12 during the long-term use of the secondary battery 100.

In some embodiments, when the sealing member 30 includes the first adhesive layer 31, the metal layer 32, and the second adhesive layer 33, the first adhesive layer 31 of the second fastening portion 302 is fixedly connected to the metal layer 32 of the first fastening portion 301. Compared with the fixed connection between the first adhesive layer 31 and the metal layer 32, the fixed connection between the first adhesive layer 31 and the second adhesive layer 33 can make the fixed connection between the first fastening portion 301 and the second fastening portion 302 more stable, helping improve the sealing effect of the sealing member 30 on the housing 10, thereby helping reduce the risk of leakage failure of the secondary battery 100.

In some embodiments, the fixed connection includes but is not limited to a connection mode of adhesive fixing or welding fixing.

In some embodiments, the first adhesive layer 31 and the metal layer 32 are fixed by adhesive, and the second adhesive layer 33 and the metal layer 32 are fixed by adhesive, so that the first adhesive layer 31, the metal layer 32, and the second adhesive layer 33 are integrated into a whole. In some embodiments, the first adhesive layer 31 and the metal layer 32 are fixed by hot pressing, and the second adhesive layer 33 and the metal layer 32 are fixed by hot pressing, so that the first adhesive layer 31, the metal layer 32, and the second adhesive layer 33 are integrated into a whole.

In some embodiments, the first adhesive layer 31 is bonded to the first side wall 112 and the second side wall 122. This helps improve the convenience of bonding the first adhesive layer 31 to the first housing body 11 and the second housing body 12.

In some embodiments, with reference to FIG. 5, the first adhesive layer 31 includes a first part 311 and a second part 312, where the first part 311 is bonded to the first housing body 11, and the second part 312 is bonded to the second housing body 12. Along the first direction X, a minimum size of the first part 311 is W₁, and a minimum size of the second part 312 is W₂, where W₁≥0.3 mm and W₂≥0.3 mm. In this case, the areas for bonding the first adhesive layer 31 to the first housing body 11 and the second housing body 12 are relatively large, and therefore the electrolyte is less likely to erode the first adhesive layer 31 along a direction parallel to the first direction X, helping reduce the risk of premature leakage failure of the secondary battery 100 along the direction parallel to the first direction X, thereby helping extend the service life of the secondary battery 100.

In some embodiments, the first adhesive layer 31 is bonded to the first housing body 11 and the second housing body 12 after being activated at a high temperature. In some other embodiments, the first adhesive layer 31 is directly bonded to the first housing body 11 and the second housing body 12.

In some embodiments, with reference to FIG. 5, the secondary battery 100 further includes a bonding member 103, where the bonding member 103 bonds the housing 10 and the electrode assembly 20, helping reduce the risk of peeling of the first adhesive layer 31 from the first housing body 11 and/or the second housing body 12 caused by the electrode assembly 20 moving in the accommodating cavity 101. In some embodiments, along the thickness direction of the electrode assembly 20, the bonding member 103 is disposed between the housing 10 and the electrode assembly 20.

In some embodiments, the insulating member 40 is integrally formed with the sealing member 30. In this case, the insulating member 40 may be directly formed by cooling after a part of the sealing member 30 is melted and enters the gap between the first housing body 11 and the second housing body 12. This simplifies the assembly process of the secondary battery 100 and the process for preparing the secondary battery 100. Moreover, since the insulating member 40 and the sealing member 30 are integrally formed, conformity to the gap between the first housing body 11 and the second housing body 12 is achieved, helping further improve the sealing performance of the sealing member 30 to the first housing body 11 and the second housing body 12.

In some embodiments, the insulating member 40 is integrally formed with the first adhesive layer 31 of the sealing member 30.

In some other embodiments, the insulating member 40 and the sealing member 30 are arranged separately. In this case, arrangement of the insulating member 40 does not depend on the melting situation of the sealing member 30, and the sealing member 30 can be disposed after the insulating member 40 is disposed between the first housing body 11 and the second housing body 12, so that the insulation reliability between the first housing body 11 and the second housing body 12 can be higher.

In some embodiments, the first adhesive layer 31 undergoing thermally-triggered melting or adhesive failure can constitute a part of a pressure relief channel communicating with the accommodating cavity 101. When thermal runaway occurs in the secondary battery 100, the first adhesive layer 31 undergoes melting or adhesive failure, and pressure in the accommodating cavity 101 can be relieved in a timely manner. This improves the safety of the secondary battery 100.

In some embodiments, a melting point of the first adhesive layer 31 is T₁, where 95° C.≤T₁≤130° C. For example, T₁ is 95° C., 100° C., 110° C., and 130° C. T₁ being greater than or equal to 95° C. can reduce the possibility that the first adhesive layer 31 undergoes melting or adhesive failure in advance before thermal runaway occurs in the secondary battery 100, helping maintain the sealing effect of the sealing member 30 on the housing 10. T₁ being less than or equal to 130° C. can ensure that when thermal runaway occurs in the secondary battery 100, the first adhesive layer 31 undergoes melting or adhesive failure in a timely manner to relieve pressure in the accommodating cavity 101, helping further improve the safety of the secondary battery 100.

In some embodiments, a melting point of the second adhesive layer 33 is T₂ where 140° C.≤T₂≤500° C. For example, T₂ is 140° C., 150° C., 200° C., 300° C., and 500° C.

In some embodiments, a material of the first adhesive layer 31 is an electrolyte-resistant high-molecular polymer, and the high-molecular polymer of the first adhesive layer 31 includes at least one of polyolefin, fluororubber, or polyurethane. A material of the second adhesive layer 33 is an electrolyte-resistant high-molecular polymer, and the high-molecular polymer of the second adhesive layer 33 includes at least one of polyolefin, fluoropolymer, polyetheretherketone, fluororubber, or polyurethane. The polyolefin may include polypropylene, polyethylene, and the like. The fluoropolymer may be, for example, polytetrafluoroethylene and the like. In this case, the first adhesive layer 31 and the second adhesive layer 33 have relatively high electrolyte corrosion resistance, helping reduce the possibility that the electrolyte corrodes the first adhesive layer 31, leading to peeling of the first adhesive layer 31 from the housing 10, or peeling of the first adhesive layer 31 of the second fastening portion 302 from the second adhesive layer 33 of the first fastening portion 301, thereby helping reduce the risk of leakage failure of the secondary battery 100. Moreover, this helps reduce the risk that the electrolyte corrodes the metal layer 32 after corroding the first adhesive layer 31.

In some embodiments, the first adhesive layer 31 includes a single layer or multiple layers of high-molecular polymer, and the second adhesive layer 33 includes a single layer or multiple layers of high-molecular polymer.

In some embodiments, a material of the metal layer 32 includes at least one of steel, aluminum, nickel, silver, copper, or their alloys.

In some embodiments, the metal layer 32 is a single-layer or multi-layer structure. For example, the multi-layer structure may be a steel layer plus an aluminum layer, a nickel layer plus a copper layer, or the like.

In some embodiments, with reference to FIG. 5, the thickness of the sealing member 30 is d₀, where 7 μm≤d₀≤1000 μm. For example, d₀ is 7 μm, 50 μm, 100 μm, 200 μm, 300 μm, 500 μm, and 1000 μm. Herein, d₀ being greater than or equal to 7 μm means that the sealing member 30 is not relatively thin, improving the overall strength of the sealing member 30, helping reduce the risk of leakage failure of the secondary battery 100 caused by damage to the sealing member 30 after the secondary battery 100 falls; and d₀ being less than or equal to 1000 μm means that the sealing member 30 is not relatively thick, reducing the space occupied by the sealing member 30 while sufficient overall strength of the sealing member 30 is ensured, helping reduce the loss of energy density of the secondary battery 100.

In some embodiments, the thickness of the sealing member 30 may be uneven, a thickness at the thinnest part of the sealing member 30 is greater than or equal to 7 μm, and a thickness at the thickest part of the sealing member 30 is less than or equal to 1000 μm.

In some embodiments, 14 μm≤d₀≤300 μm. For example, d₀ is 14 μm, 50 μm, 100 μm, 150 μm, 200 μm, 250 μm, and 300 μm. Herein, d₀ being greater than or equal to 14 μm can improve the overall strength of the sealing member 30, helping further reduce the risk of leakage failure of the secondary battery 100 caused by damage to the sealing member 30 after the secondary battery 100 falls; and d₀ being less than or equal to 300 μm allows the sealing member 30 to maintain sufficient overall strength for most falling situations, further reducing the space occupied by the sealing member 30, helping further reduce the loss of energy density of the secondary battery 100.

In some embodiments, the thickness of the sealing member 30 may be uneven, a thickness at the thinnest part of the sealing member 30 is greater than or equal to 14 μm, and a thickness at the thickest part of the sealing member 30 is less than or equal to 300 μm.

In some embodiments, when the sealing member 30 includes the first adhesive layer 31, the metal layer 32, and the second adhesive layer 33, since the first adhesive layer 31 is more likely to contact the electrolyte than the second adhesive layer 33, and the first adhesive layer 31 needs to be welded to the second adhesive layer 33, the thickness of the first adhesive layer 31 needs to be greater than the thickness of the second adhesive layer 33.

Refer to FIG. 9. An embodiment of this application provides an electric device 1000, including the secondary battery 100 as described above. The secondary battery 100 has relatively good sealing performance, and therefore electrolyte leakage is less likely, helping extend the service life of the electric device 1000. The secondary battery 100 has less loss of energy density, and the battery capacity can be higher, helping improve the endurance capability of the electric device 1000. The electric device 1000 includes but is not limited to electronic devices such as mobile phones, tablet computers, and notebook computers.

In addition, those of ordinary skill in the art should recognize that the above embodiments are only used to illustrate this application, and are not used as a limitation to this application. As long as within the essential scope of this application, appropriate changes and variations made to the above embodiments fall within the scope disclosed by this application.

What is claimed is:

1. A secondary battery, comprising:
a housing, wherein the housing comprises a first housing body and a second housing body, the first housing body and the second housing body together form an accommodating cavity, and the accommodating cavity is filled with an electrolyte; the first housing body comprises a first wall and a first side wall connected to a periphery of the first wall, and the second housing body comprises a second wall and a second side wall connected to a periphery of the second wall; along a first direction, the first wall is disposed opposite to the second wall, and the first side wall is joined to the second side wall; and the housing has a corner portion, a part of the corner portion is disposed on the first side wall, and another part of the corner portion is disposed on the second side wall;
an electrode assembly, wherein the electrode assembly is disposed in the accommodating cavity; and
a sealing member, wherein the sealing member is disposed around the periphery of the first housing body and the periphery of the second housing body, and seals a joint between the first side wall and the second side wall; the sealing member comprises a first fastening portion and a second fastening portion disposed at two end portions along an extension direction of the sealing member; along a thickness direction of the sealing member, the first fastening portion and the second fastening portion are stacked on the corner portion; and the first fastening portion is fixedly connected to the second fastening portion.

2. The secondary battery according to claim 1, wherein the sealing member further comprises a third fastening portion, one end of the third fastening portion is connected to the first fastening portion, and another end of the third fastening portion is connected to the second fastening portion; along an extension direction of the corner portion, the corner portion has a first boundary and a second boundary; along a direction perpendicular to the first boundary and a direction perpendicular to the second boundary, projections of the first fastening portion and the second fastening portion both are located within a projection range of the third fastening portion.

3. The secondary battery according to claim 1, wherein observed along the first direction, the corner portion is arc-shaped; and the first direction is parallel to a thickness direction of the housing.

4. The secondary battery according to claim 3, wherein the secondary battery further comprises a first tab, and the first tab is connected to the electrode assembly and extends out of the electrode assembly along a second direction; along a third direction, a projection of the corner portion at least partially covers a projection of the first tab; and the first direction, the second direction, and the third direction are perpendicular to each other.

5. The secondary battery according to claim 4, wherein the electrode assembly comprises a first edge; the first tab extends out of the first edge along the second direction; along the second direction, a distance between the first edge and the housing is D; and a radius of the corner portion is R, wherein 0.77 mm≤R≤D.

6. The secondary battery according to claim 3, wherein observed along the first direction, a length of the corner portion is L₁, and a length of the second fastening portion is L₂, wherein 0.3 mm≤L₂<L₁.

7. The secondary battery according to claim 6, wherein a thickness of the sealing member is d₀, wherein 14 μm≤d₀≤300 μm.

8. The secondary battery according to claim 1, wherein the sealing member comprises a first adhesive layer and a metal layer, the first adhesive layer is bonded to the first housing body and the second housing body, and the metal layer is disposed on a side of the first adhesive layer facing away from the first housing body and the second housing body.

9. The secondary battery according to claim 8, wherein the sealing member further comprises a second adhesive layer, and the second adhesive layer is disposed on a side of the metal layer facing away from the first adhesive layer.

10. The secondary battery according to claim 1, wherein a positive electrode of the electrode assembly is electrically connected to the first housing body, a negative electrode of the electrode assembly is electrically connected to the second housing body, and the first housing body is insulated from the second housing body.

11. The secondary battery according to claim 10, wherein the secondary battery further comprises an insulating member; along the first direction, a gap exists between the first side wall and the second side wall; and the insulating member is disposed in the gap and connects the first side wall and the second side wall.

12. The secondary battery according to claim 11, wherein the insulating member is integrally formed with the sealing member.

13. An electric device, comprising a secondary battery, and the secondary battery comprises:
a housing, wherein the housing comprises a first housing body and a second housing body, the first housing body and the second housing body together form an accommodating cavity, and the accommodating cavity is filled with an electrolyte; the first housing body comprises a first wall and a first side wall connected to a periphery of the first wall, and the second housing body comprises a second wall and a second side wall connected to a periphery of the second wall; along a first direction, the first wall is disposed opposite to the second wall, and the first side wall is joined to the second side wall; and the housing has a corner portion, a part of the corner portion is disposed on the first side wall, and another part of the corner portion is disposed on the second side wall;
an electrode assembly, wherein the electrode assembly is disposed in the accommodating cavity; and
a sealing member, wherein the sealing member is disposed around the periphery of the first housing body and the periphery of the second housing body, and seals a joint between the first side wall and the second side wall; the sealing member comprises a first fastening portion and a second fastening portion disposed at two end portions along an extension direction of the sealing member; along a thickness direction of the sealing member, the first fastening portion and the second fastening portion are stacked on the corner portion; and the first fastening portion is fixedly connected to the second fastening portion.

14. The electric device according to claim 13, wherein the sealing member further comprises a third fastening portion, one end of the third fastening portion is connected to the first fastening portion, and another end of the third fastening portion is connected to the second fastening portion; along an extension direction of the corner portion, the corner portion has a first boundary and a second boundary; along a direction perpendicular to the first boundary and a direction perpendicular to the second boundary, projections of the first fastening portion and the second fastening portion both are located within a projection range of the third fastening portion.

15. The electric device according to claim 13, wherein observed along the first direction, the corner portion is arc-shaped; and the first direction is parallel to a thickness direction of the housing.

16. The electric device according to claim 15, wherein the secondary battery further comprises a first tab, and the first tab is connected to the electrode assembly and extends out of the electrode assembly along a second direction; along a third direction, a projection of the corner portion at least partially covers a projection of the first tab; and the first direction, the second direction, and the third direction are perpendicular to each other; and/or,
the electrode assembly comprises a first edge; the first tab extends out of the first edge along the second direction; along the second direction, a distance between the first edge and the housing is D; and a radius of the corner portion is R, wherein 0.77 mm≤R≤D.

17. The electric device according to claim 15, wherein observed along the first direction, a length of the corner portion is L1, and a length of the second fastening portion is L2, wherein 0.3 mm≤L2<L1; and/or,
a thickness of the sealing member is d0, wherein 14 μm≤d0≤300 μm.

18. The electric device according to claim 13, wherein the sealing member comprises a first adhesive layer and a metal layer; the first adhesive layer is bonded to the first housing body and the second housing body, and the metal layer is disposed on a side of the first adhesive layer facing away from the first housing body and the second housing body; and/or,
the sealing member further comprises a second adhesive layer, and the second adhesive layer is disposed on a side of the metal layer facing away from the first adhesive layer.

19. The electric device according to claim 13, wherein a positive electrode of the electrode assembly is electrically connected to the first housing body, a negative electrode of the electrode assembly is electrically connected to the second housing body, and the first housing body is insulated from the second housing body.

20. The electric device according to claim 19, wherein the secondary battery further comprises an insulating member; along the first direction, a gap exists between the first side wall and the second side wall; and the insulating member is disposed in the gap and connects the first side wall and the second side wall; and/or,
the insulating member is integrally formed with the sealing member.
